(19) United States
(12) Patent Application Publication
(10) Pub. No.: US 2002/0130772 A1
(43) Pub. Date: Sep. 19, 2002

(54) State detector of vehicle headlamps

(76) Inventor: Weiguang Qian, Irvine, CA (US)

Correspondence Address: WEIGUANG QIAN, 281 GIOTTO, IRVINE, CA, 92614, US

(21) Appl. No.: 09/808,474

(22) Filed: Mar. 15, 2001

(51) Int. Cl. B60Q 1/00

(52) U.S. Cl. 340/457.2; 340/425.5

(57) ABSTRACT

This invention is a state detector of vehicle headlamps. It uses electronic technique to compare curvature of vehicle battery discharging curve and determine whether or not the driver forges to turn off headlamps. Its merit is that once installed, it works automatically in any kind of cars. It is very convenient to use.

The reason of Inverting this device is the unhappy experience people have forgetting to turn off their vehicle headlamps when they stop engine and left. The result is very annoying. The car is dead. Some vehicles with “DAYTIME RUNNING LIGHTS CONTROLLER”. That is a logical controller. The vehicle sensors detect and logically determine when and how to turn off headlamps automatically or to functions breeze.

But most vehicles have not this function.

Inventor can not fine any products like mine on market in this field.

The particular of this invention is a state detector of vehicle headlamps that uses electronic technique to compare with curvature of discharge curve of vehicle battery when this curvature detected exceeds curvature already set up this device functions.

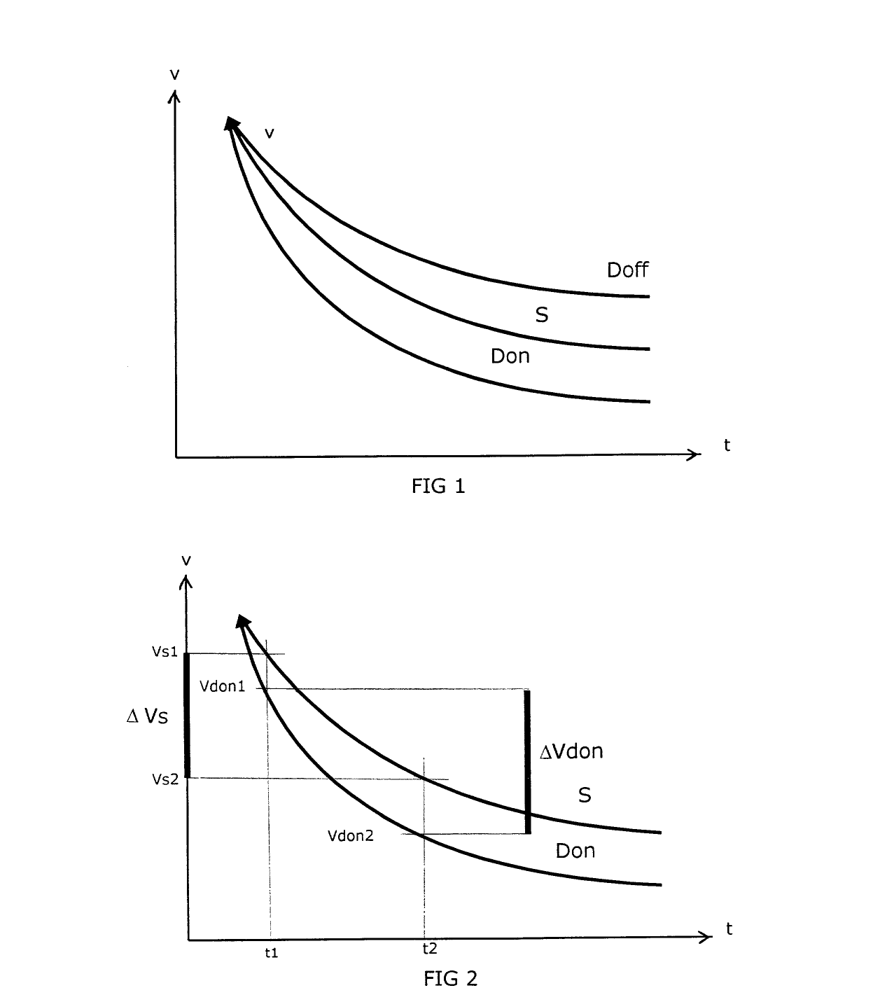

Because battery discharge curve has a good approximation with exponent curve. Refer to FIG. 1, different battery discharging rate has different discharge curve and different curvature. When vehicle engine is stopped , there are two possibilities:

(a) When driver forgets to turn off vehicle headlamps the battery discharge curve is defined as “Don” and its curvature is defined as “Con”.

(b) When driver turn off vehicle headlamps immediately, the battery discharge curve is defined as “Doff” and its curvature is defined as “Coff”.

Inventor set up a detecting curve, it is defined as “S” and its curvature is defined as “Cs”.

According to FIG. 1, we can see clear: Coff<Cs<Con

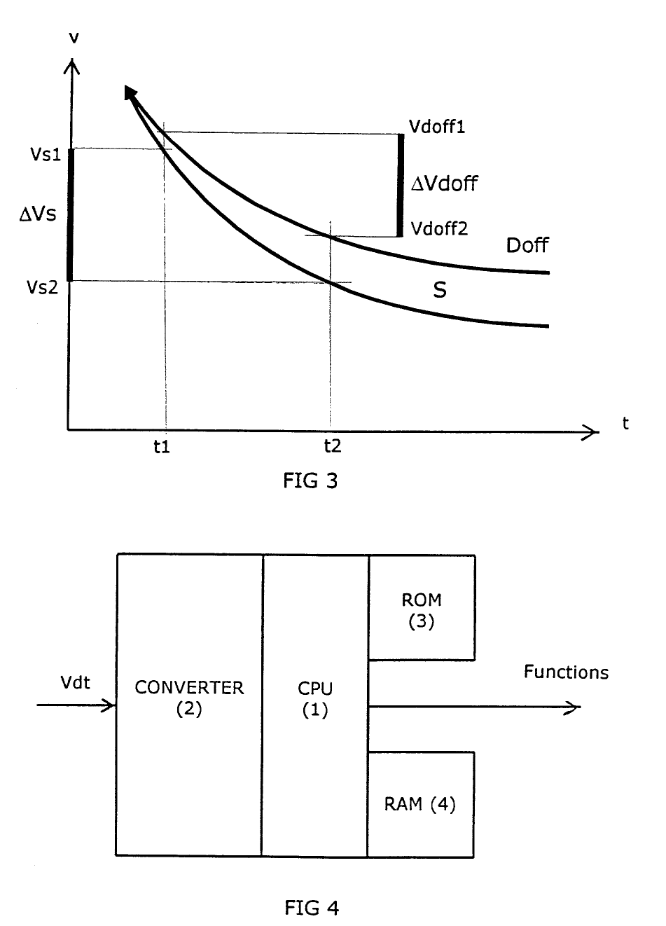

FIG. 2 and FIG. 3 explains the ways of comparing curvature.

### In FIG. 2 and FIG. 3:

Vs1 is defined as voltage on curve S when it is at time t1;

Vs2 is defined as voltage on curve S when it is at time t2;

ΔVs=Vs1−Vs2

In FIG. 2:

Vdon1 is defined as voltage on curve Don when it is at time t1;

Vdon2 is defined as voltage on curve Don when it is at time t2;

ΔVdon=Vdon1−Vdon2

We can see clearly: ΔVdon>ΔVs, It means curvature Con>Cs.

In FIG. 3:

Vdoff1 is defined as voltage on curve Doff when it is at time t1;

Vdoff2 is defined as voltage on curve Doff when it is at time t2;

ΔVdoff=ΔVdoff1−Vdoff2

We can see clearly: AVdoff<ΔVs, It means curvature Coff<Cs.

Inventor set up a new symbol Vdt: it is defined as voltage of vehicle battery when it is at time t . Vdt come from input of detector. So ΔVdt is defined as voltage change of vehicle battery when it is at time t and time (t−1). We can see clearly:

ΔVdt=Vd(t−1)−Vdt

If ΔVdt<ΔVs: it means driver has turned off vehicle headlamps.

If ΔVdt>ΔVs it means driver forgot turn off vehicle headlamps.

Therefore the usage of electronic technique can simulate the way of comparison of curvature mentioned above, thus—detecting whether or not “ON” and “OFF” of the headlamps

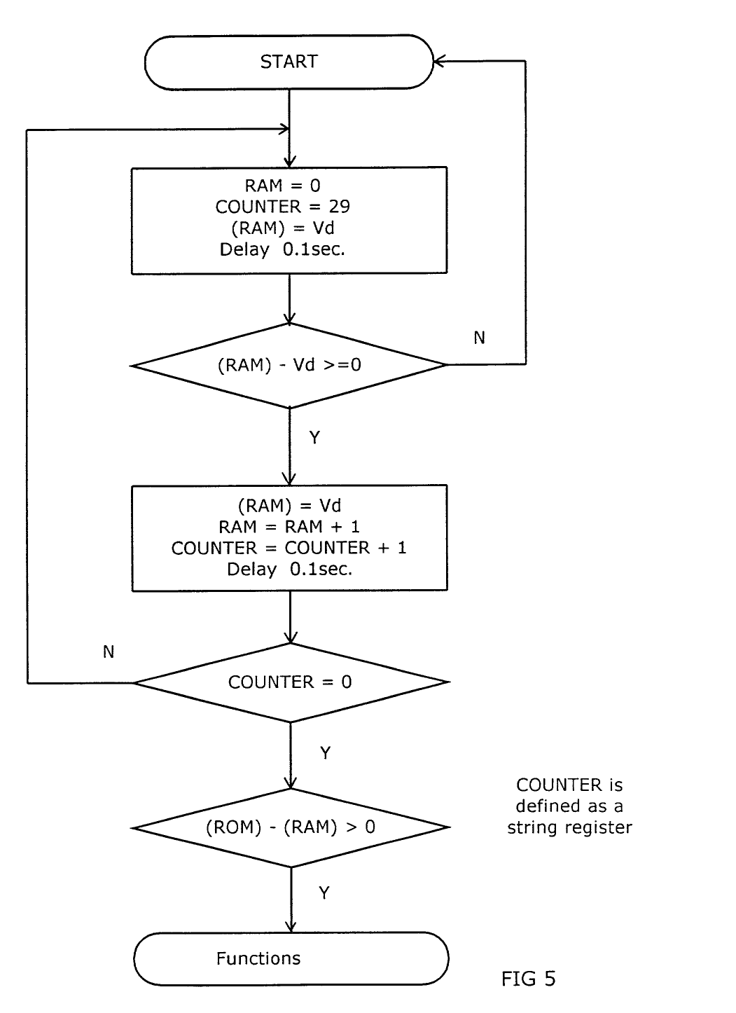

Inventor has experimented a circuit shown in FIG. 4 by using microprocessor. The circuit includes CPU(1), A/D converter(2), RAM(3) and ROM(4). The A/D converter(2) collects Vdt the input voltage of vehicle battery continuously with a 0.1 sec. Cycle time. The CPU(1) runs program that is store in ROM(3). The flowchart of program shown in FIG. 5. Inventor set up a string of ΔVst. ΔVst is defined as a string of testting voltage change when it is at time t. The time t is from 0,1,2 . . . to n. Inventor setting n=29 in this circuit. This string is stored in ROM(3) with 30 dates. The voltage of vehicle battery is dropping when driver stopped engine. Refer to FIG. 5, RAM(4) start to storing ΔVdt. This circuit start to comparing ΔVdt with ΔVst. This detector will functions if ΔVdt>ΔVst.

### BRIEF SUMMARY

This invention makes the usage of electronic technique to compare the curvature of vehicle battery discharging curve. By using this method invention detects the fact that the driver forgets or not to turn off the headlamps after the engine is stopped. It has extensive practical value.

1. The particular of this invention is a state detector of vehicle headlamps that uses electronic technique to compare with curvature of discharge curve of vehicle battery when this curvature detected exceeds curvature already set up this device functions.
